(19) United States
(12) Patent Application Publication
(10) Pub. No.: US 2007/0262981 A1
(43) Pub. Date: Nov. 15, 2007

(54) 3-D Reconstruction With Oblique Geometry

(76) Inventors: Joachim Hey, Bornheim (DE); Marc Lievin, Bonn (DE); Manfred Breuer, Alfter (DE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/660,541

(22) PCT Filed: Aug. 9, 2005
(86) PCT No.: PCT/EP05/08613

§ 371 Date: Feb. 20, 2007

(30) Foreign Application Priority Data
Aug. 20, 2004 (DE) 10 2004 040 677.4
Oct. 14, 2004 (DE) 10 2004 050 172.6

(51) Int. Cl. G06T 11/00

(52) U.S. Cl. 345/419

(57) ABSTRACT

The invention relates to a method for producing 3D tomographic images of an object, whereby a radiation source (1), especially an X-ray source, is moved in relation to the object in a plane of motion (6) about a rotating center. The radiation source (1) emits radiation in a radiation cone (2) whose center beam (3) impinges the object. A correspondingly entrained detector (4) is arranged in said center beam, on the side of the object facing away from the radiation source, and is impinged upon by the radiation attenuated in its intensity by the object. The movement is carried out in such a manner that the center beam (3) is tilted by an angle in relation to the plane of motion (6).

The present invention relates to a method for producing three-dimensional tomographic images of an object, wherein a source of radiation, especially a source of X-rays, is moved in relation to the object in a plane of travel about a center of rotation, wherein the source of radiation emits radiation in a radiation cone whose center beam impinges on the object and an correspondingly entrained detector is disposed in said center beam on the side of the object remote from the source of radiation and is impinged upon by the radiation attenuated in its intensity due to passage thereof through the object. The present invention also relates to a device for implementing such a method.

Tomographic imaging is nowadays an important technique in the field of medicine for creating images of a transilluminated object or the body. The object is irradiated using a source of X-rays, which is moved around the object along a predetermined path. A detector is disposed in the beam path behind the object, which detector comprises an array of detector elements onto which the object is projected. The individual detector elements record certain rays of the beam of X-rays that impinge on the array and are attenuated due to absorption in the object, and an image is generated by means of a computer from the resulting signals.

In the technique mentioned above, a beam having a conical geometry is used, wherein the source of X-rays projects the light cone onto the object. The detector elements are impinged upon by the two-dimensional projection of the object. Projections are collected from various directions by the movement of the source and the detector, said source and detector being in fixed relationship to one another. This technique enables the reconstruction of the volume enclosed by the transilluminated object. In a particularly preferred arrangement, the source of X-rays and the detector are each disposed at different ends of a C-shaped arc, which is rotated about its center axis to move around the object, by which means a plurality of two-dimensional images is recorded. It is possible to reconstruct the object in its three dimensionality from these projections. The source of radiation performs a circular or elliptical movement in the cone beam techniques known in the prior art, the center beam being perpendicular to the axis of rotation.

Feldkamp's cone-beam technique is used for reconstructing the three-dimensional objects (“Practical Cone-Beam Algorithms” by L. A. Feldkamp, et al. J. Opt. Soc. Am. A/Edition 1, No. 6, June 1984). In this method, which is also known by the term “filtered back projection” (FBP), all of the projection images are first filtered and then back-projected in their spatial form. The method is used in commercial tomographic scanners, particularly in spiral CTs or cone-beam C-shaped arms.

Systems of this type require calibration of the geometry in order to make it possible to reconstruct the three-dimensional image correctly. The calibration can take place online during the scan or offline, the offline calibration being carried out just once with reference to a reference object (calibration phantom) of known geometry.

The disadvantage of the methods known hitherto is that they react with relative sensitivity to irregularities in the object—particularly in the case of dental applications—containing artifacts. The production of tomographic images of the human jaw may be mentioned here, the quality of said images being greatly dependent on the distribution of metal crowns present in the teeth. Furthermore, in the methods known in the prior art, it is difficult to take into account the anatomy of each individual body.

It is an object of the present invention to provide a method of the type defined above, which can be implemented cost-effectively using simple means and which ensures high image quality while involving reduced exposure to radiation. Another object of the present invention is to provide a mechanically simply constructed device for implementing said method.

These objectives are achieved by the method having the features defined in claim 1 and by the device as defined in claim 8. The features of special embodiments of the present invention are defined in the respective subclaims.

The basic concept of the present invention is to provide an imaging method and appropriate cone-beam apparatus in which the center beam is inclined at an angle relative to the plane of travel instead of being aligned with the plane of travel, as has hitherto been the case. Since, in most cases, said movement is movement of rotation around the object to be examined, the center beam is inclined at an appropriate angle to the plane of rotation and thus is no longer normal to the axis of rotation.

This does not rule out the possibility of linear motion along the axis of rotation being superimposed on the rotary motion, as in the case of a spiral CT. In such a case, the plane of travel is inclined and forms a spiral. According to the present invention, in this case also, the center beam and the axis of rotation enclose an angle that is not equal to 90°. In other special cases, for example in order to leave out the shoulder area when imaging the lower jaw, it can be advantageous to leave the plane of rotational travel over a defined angular region before returning to said plane subsequently. The source of radiation and the detector initially perform an upward motion before being lowered again into the former plane of travel. The motion is closed in this case. These special cases are also included within the scope of the present invention.

However, due to the mathematically simpler reconstruction of the images and due to the more easily interpreted contents of the images, it is particularly advantageous when the plane of rotation is perpendicular to the axis of rotation, as in the case of conventional examination using a C-shaped arc, and also when the path of travel is elliptical or circular. Another advantage of this embodiment of the present invention is the simple mechanical implementation thereof. In general, the advantages of the present invention are the low degree of exposure to radiation and the reduction of artifacts, thus resulting in a significant increase in image quality. The anatomical advantages for a dental application are described below in detail.

These advantages are particularly noteworthy when implementing the present invention in conjunction with the C-shaped arcs known in the prior art, in which the axis of rotation of the system comprising the source of X-rays and the detector has hitherto been exclusively perpendicular to the center X-ray beam. However, it is also possible to calibrate the system when the center beam is positioned according to the present invention such that it is not perpendicular to the axis of rotation.

A special advantage of the present invention is the mechanical configuration and this becomes apparent in dental imaging using a C-shaped arc. The angle of the center beam can be adjusted such that the lower marginal ray extends in an approximately horizontal direction. The geometry of this adjustment firstly enables the detector to pass by the shoulders of the patient easily. In doing so, the detector can be brought closer to the patient, by means of which the projection volume can be increased and the dimensions of the device optimized.

Another advantage of the present invention concerns the absorption of the radiation dose. The oblique geometry thus makes it possible to keep certain anatomical structures, such as the base of the skull, away from the beam path, since such anatomical structures are particularly sensitive and highly radiation-absorptive. This avoids measuring artifacts, such as radiation intensifying products which are formed by these anatomical structures. The radiation dose for the patient can thus be reduced while retaining the same image quality.

Furthermore, it is advantageous that artifacts created by metal objects can be reduced with the help of the present invention. Thus metal artifacts resulting from an intensified absorption (occlusions), as is the case, for example, when several dental fillings are present, are prevented when using C-shaped arcs. Objects having a high absorption capacity can absorb the X-rays completely, which results in a lack of information in the recorded data set. This loss of information then creates artifacts particularly when the classic reconstruction algorithms are used in which the process of back projection consists of a summation, which summation is inconsistent in the case of occlusions and the values lying outside the permissible range reach saturation.

For evaluation purposes, it is advantageous to use the principle of the aforementioned Feldkamp reconstruction, in which all the subrays recorded from different angles are summated for the reconstruction of the spatial representation. Due to their low computation complexity, it is advantageous to consider projections from opposing angles (0° and 180°) which can no longer be superimposed. The fact that the center beam is not perpendicular to the axis of rotation can produce small artifacts, which can be attributed to uncompensated information during the back-projection step. Experiments have shown that artifacts resulting from metal absorption are much stronger than those created by uncompensated information. Therefore, the detriment caused here is very small.

It is advantageous to use the cone-beam reconstruction of defined offline calibration phantoms for C-shaped arcs (“Calibration phantoms for projection X-ray systems” by Mitschke et al., U.S. Pat. No. 6,715,918). This phantom is a circular spiral composed of balls, which represent a binary code. The projected balls form patterns that can be decoded. The position of each ball is therefore known in three-dimensional space and also in two-dimensional images. The geometry can be found by an inversion of the projection matrix. These matrices are used in order to reconstruct the three-dimensional image. This phantom enables the use of any arrangement of the axis of rotation, the center beam, and the detector surface using any cone-beam geometry.

The present invention is explained below in detail with reference to the figures, in which:

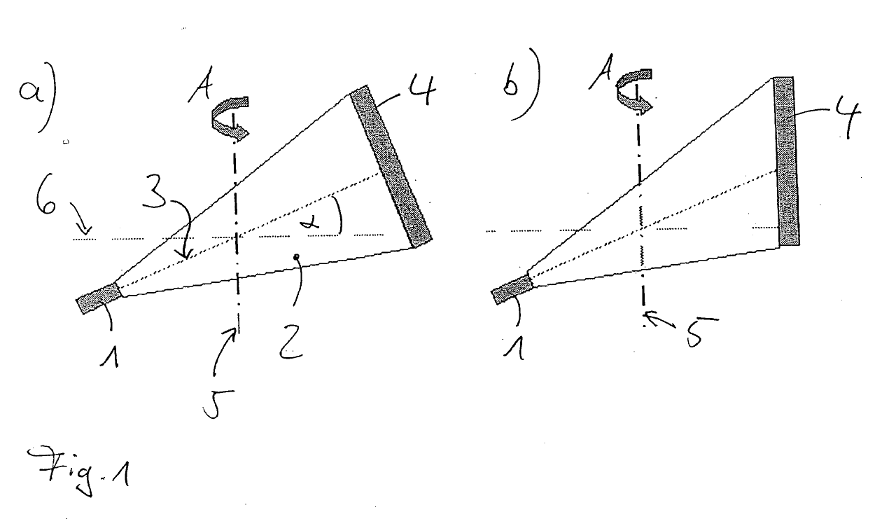

FIG. 1 is a diagrammatic view of a cone-beam scanner system having a source and a detector,

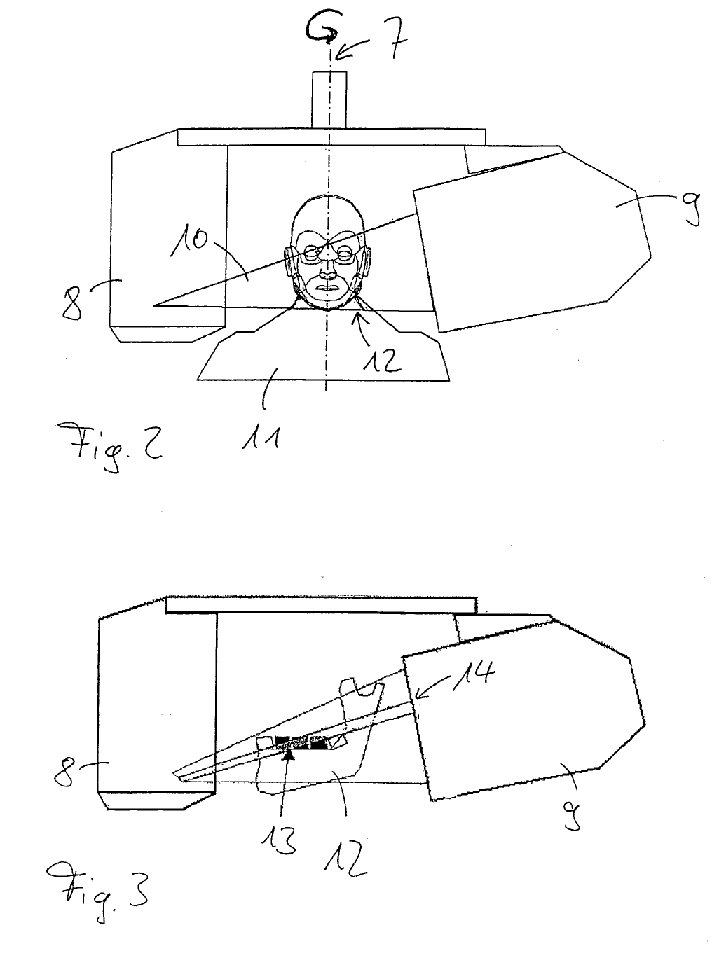

FIG. 2 shows an oblique geometry of a dental cone-beam scanner, and

FIG. 3 shows a beam passing through dental fillings.

FIG. 1 shows diagrammatically a cone-beam scanner system having a source 1 for X-rays. The source 1 emits a cone beam having a center beam 3. After passing through an object (not illustrated), the beam 2 impinges on a detector array 4, which comprises a plurality of individual detectors. Each of the detectors records a subray of the cone beam 2, which subray is attenuated by its transillumination of the object. The arrangement consisting of the source 1 and detector 4 is rotated about an axis 5 (arrow A) for subsequent generation of a three-dimensional reconstruction of the object. The rotational motion defines a plane that is parallel to the plane 6 of the drawing in the figure. According to the present invention, the center beam 3 is inclined at an angle α in relation to the plane of travel 6. The angle α can be adjusted according to circumstances. Unlike the example shown in FIG. 1a, in which the center beam 3 impinges on the detector 4 perpendicularly, the arrangement of the detector 4 shown in FIG. 1b is parallel to the axis of rotation 5. The two exemplary embodiments thus differ from one another solely with regard to the formalisms forming the basis of the mathematical evaluation.

FIG. 2 shows a “C-shaped arc”, which is rotatable about the axis 7, and has a source of X-rays 8 and an obliquely disposed detector 9. The cone-beam 10 transilluminates the lower skull of a patient 11. It can be clearly seen that the degree of inclination of the source 8 and the detector is selected such that the lower marginal beam 12 extends in a horizontal direction. This arrangement makes it possible to avoid irradiation of the shoulders and to bring the detector 9 relatively close to the patient 11.

FIG. 3 shows the same arrangement of a “C-shaped arc” and illustrates the lower jaw 12 of the patient. Metallic fillings 13 are located in the teeth of the lower jaw, which fillings 13 block the radiation in the region 14 and thus bring about artifacts in the reconstruction. However, it can also be clearly seen that, in principle, due to the oblique arrangement, the center beam passes through only one filling instead of all three of the existing fillings 13. The occlusion is thus reduced.

1. A method for producing three-dimensional tomographic images of an object comprising moving a source of radiation in relation to the object in a plane of travel about a center of rotation, emitting from the source of radiation radiation in a cone beam whose center beam impinges on the object, placing a correspondingly entrained detector in said center beam on a side of the object remote from the source of radiation so as to be impinged upon by the radiation attenuated in its intensity due to passage thereof through the object, and moving said source of radiation in such a manner that the center ray is inclined at an angle relative to a plane of travel.

2. The method as defined in claim 1, wherein the detector exhibits an array of detector elements, the object being projected onto the array during the motion whilst the signals of the detector elements which are collected during the motion are implemented to provide a tomographic image containing three-dimensional information.

3. The method as defined in claim 1, comprising causing the source of radiation to move around the object along the path of a conical section and the detector disposed in the optical path of the center ray follows the motion accordingly.

4. The method as defined in claim 1, wherein the detector array is impinged upon by almost the entire cone beam, and the active surface of the detector array is disposed perpendicularly to the center ray.

5. The method as defined in claim 1, wherein the detector array is impinged upon by at least almost the entire cone beam, and the active surface of the detector array is disposed parallel to an axis of rotation.

6. The method as defined in claim 1, comprising changing the angle of inclination of the source and/or of the detector is during the motion.

7. The method as defined in claim 1, comprising moving the source of radiation and the detector along an axis of rotation during the rotational motion.

8. A device for execution of the method as defined in claim 1 comprising a source of X-rays and a detector, wherein a cone beam of the source of X-rays impinges on an array of detector elements of the detector, and the device is capable of being rotated about an axis of rotation, the center ray of the cone beam is being inclined at an angle to a plane of rotation.

9. The device as defined in claim 8, wherein the angle of inclination of the source and/or of the detector is variable.

10. The device as defined in claim 8, wherein a lower marginal ray of the cone beam describes a horizontal plane during rotation.

11. (canceled)
